(19) United States
(12) Patent Application Publication
(10) Pub. No.: US 2011/0309769 A1
(43) Pub. Date: Dec. 22, 2011

(54) POWER CONTROL DEVICE FOR LED LIGHTING AND LIGHTING SYSTEM

(75) Inventors: Taisuke Kuroki, Tokyo (JP); Takayuki Katayama, Tokyo (JP); Masaaki Komagata, Tokyo (JP); Noboru Sugie, Tokyo (JP); Takeshi Suzuki, Tokyo (JP)

(73) Assignee: MITSUMI ELECTRIC CO., LTD., Tama-shi (JP)

(21) Appl. No.: 13/012,093

(22) Filed: Jan. 24, 2011

(30) Foreign Application Priority Data
Jun. 17, 2010 (JP) 2010-138315
Aug. 4, 2010 (JP) 2010-089085

(51) Int. Cl. H05B 37/02

(52) U.S. Cl. 315/294; 315/291

(57) ABSTRACT

A lighting system including a power control device for controlling illuminance of a lighting fixture by outputting current to drive the lighting fixture and controlling the current, a plurality of lighting fixtures each driven to be lit by the power control device, and a switch device incorporating an energy self-supplying unit converting an operating force of a switch button into electric energy. The power control device includes a first circuit section having a receiver for receiving a wireless signal having a predetermined frequency and a control signal generating circuit for generating a control signal according to the number of times of reception of the wireless signal and operated by a first power system and a second circuit section operated by a second power system and outputting current according to the control signal from the first circuit section, and the second power system is not operated when not outputting current.

### BACKGROUND OF THE INVENTION

1. Field of the Invention

The present invention relates to a power control device for a lighting fixture, that is, a power control device for turning on/off and light control of LED lighting, and more specifically relates to a power control device for LED lighting using a wireless switch that does not require a battery and a lighting system using the same.

2. Description of the Related Art

Recently, in order to reduce carbon dioxide emissions, LED lighting, which has low power consumption, is spreading instead of an incandescent lamp, which has high power consumption. Also, a technique of controlling light in an LED lighting apparatus has been proposed (e.g., refer to Japanese Patent Application Laid-Open publication No. 2009-301876).

There is a case in which a plurality of LED lighting fixtures (each hereinafter referred to as an LED lamp) are installed with a predetermined distance on a ceiling of a relatively large building. To construct a lighting system to perform light control of the plurality of LED lamps in a conventional technique, power switches SW1, SW2 . . . and light control dials D1, D2 . . . for LED lamps L1, L2 . . . and wiring to connect the switches and dials to the LED lamps need to be provided, as shown in FIG. 9.

Thus, the more the number of LED lamps to be installed increases along with enlargement of the building, the more the number and length of wires increase, which causes problems in which wiring installing work becomes more complicated, it takes longer time for the work, and the wires may be connected wrongly more highly possibly.

Under such circumstances, the present inventors have considered a lighting system of a type that light control of a plurality of LED lamps is performed with use of a wireless switch that does not require a battery or a wireless transmitter incorporating an energy self-supplying unit. A lamp control technique with use of an energy self-supplying type wireless transmitter is described in Japanese Unexamined Patent Application Publication (Translation of PCT Application) No. 2003-534704, for example.

However, as described in Japanese Patent Application Laid-Open Publication No. 2009-301876, to control brightness of a lamp in several levels, a command will be given by means of a radio frequency telegram or a command code. This causes a problem in which a circuit performing light control becomes complicated and expensive since the lamp side requires not only a receiver but also a unit such as a CPU to decode the code.

### SUMMARY OF THE INVENTION

The present invention has been made to solve the foregoing technical problems, and an object of the present invention is to provide a power control device for LED lighting capable of performing light control of a plurality of LED lamps merely by providing a relatively simple circuit in a lighting system in which the plurality of LED lamps are used and controlled by a wireless switch, and the lighting system.

According to a first aspect of the present invention, there is provided a power control device capable of controlling illuminance of a lighting fixture by outputting current that drives the lighting fixture and controlling the current, including: a first circuit section including a receiver for receiving a wireless signal having a predetermined frequency, a control signal generating circuit for generating a control signal according to the number of times of reception of the wireless signal at the receiver, and a first alternating current-direct current conversion circuit for converting alternating-current voltage into direct-current voltage; and a second circuit section for generating and outputting current according to the control signal from the first circuit section, the second circuit section including a second alternating current-direct current conversion circuit for converting alternating-current voltage into direct-current voltage, wherein the first alternating current-direct current conversion circuit is in a state of being operated at all times, and the second alternating current-direct current conversion circuit is operated when outputting driving current for the lighting fixture according to the control signal from the control signal generating circuit and is not operated when not outputting driving current.

With the above configuration, since the power control device generates and outputs driving current for the lighting fixture according to the number of times of reception of the wireless signal, a transmitting device for a wireless signal has only to transmit a simple wireless signal that does not contain data such as a code. Thus, the device transmitting a wireless signal to the power control device can be a device with a simple structure or function.

Also, the power control device includes the first circuit section and the second circuit section each having the alternating current-direct current conversion circuit for converting alternating-current voltage into direct-current voltage, and the alternating current-direct current conversion circuit of the first circuit section is in a state of being operated at all times and the alternating current-direct current conversion circuit of the second circuit section is operated when outputting driving current for the lighting fixture. Thus, since the power consumption can be reduced while the lighting fixture is off, the power consumption of the entire lighting system can be reduced in a case of constructing a light controllable system with use of an LED lamp, which is an energy-saving lighting fixture.

Preferably, the power control device may be configured to be that illuminance of the lighting fixture is changed by changing the magnitude of driving current for the lighting fixture to be output from the second circuit section according to the number of times of reception of the wireless signal. Accordingly, the switch device may only have one switch button, and a user can change brightness of the lighting fixture each time the user operates the switch device and does not need button selection, which brings about easy switch operations.

Preferably, the power control device may be configured to be that the lighting fixture is an LED lamp incorporating a red LED, a blue LED, and a green LED, the second circuit section is configured to be capable of outputting respective driving currents for the respective colors of the LED lamp, and the second circuit section is capable of changing an emission color of the lighting fixture by changing the number and combination of the driving currents to be output according to the number of times of reception of the wireless signal at the receiver. Accordingly, the user can change the emission color of the lighting fixture each time the user operates the switch device, the atmosphere in the space in which the lighting system has been installed can be changed, and optimal visual representation that meets a purpose can be easily done.

Preferably, the control signal generating circuit includes: a counter for counting the number of times of reception of the wireless signal; and a decoder for decoding a value of the counter to generate the control signal. Accordingly, a design change of a circuit in a case of changing the number of brightness levels or the number of emission colors for the lighting fixture is simplified.

Preferably, the control signal generating circuit includes: a counter capable of automatic incremental update and decremental update; a conversion circuit configured to convert a value of the counter to generate the control signal; and a counter operation control section configured to change the operation state of the counter in response to reception of the wireless signal at the receiver. Accordingly, it is possible to perform light control such as fade-in or fade-out in which brightness of the lighting fixture is gradually changed automatically at the time of reception of the wireless signal from the wireless switch or the like.

Preferably, the control signal generating circuit includes: a storage unit that has stored therein an ID code, an identify section for identifying an ID code contained in the wireless signal received at the receiver, and a counter operation control section for changing the operation state of the counter in a change mode associated with the ID code contained in the wireless signal received at the receiver. Accordingly, by giving a different ID code to each of a plurality of wireless switches and transmitting a wireless signal containing the ID code, the control signal generating circuit that has received the wireless signal can perform light control in which brightness of the lighting fixture is changed in a different change mode depending on the received ID code.

According to a second aspect of the present invention, there is provided a lighting system including: the power control device according to claim 1; a lighting fixture driven to be lit by the power control device; and a switch device incorporating a switch button and an energy self-supplying unit converting an operating force of the switch button into electric energy, wherein the switch device includes a transmitter capable of transmitting a wireless signal having a predetermined frequency and is configured to transmit the wireless signal when the switch button is operated. Accordingly, since the energy to be generated by the energy self-supplying unit or the moving distance of the switch button can be small, the switch device can be reduced in size or thickness.

Preferably, the lighting system includes: a plurality of switch devices each incorporating a switch button and an energy self-supplying unit converting an operating force of the switch button into electric energy; a plurality of lighting fixtures; and the power control devices according to claim 6 provided to correspond respectively to the plurality of lighting fixtures, wherein each of the plurality of switch devices is configured to be capable of transmitting a wireless signal containing a unique ID code, and each of the power control devices changes driving current to be output to the corresponding lighting fixture when receiving the wireless signal containing a predetermined ID code. With the above configuration, since each of the switch devices transmits a wireless signal containing a different ID code, the power control device can perform different light control depending on the operated switch device. Namely, a different function can be given to each switch device.

Preferably, the power control device includes a transmitter for transmitting a wireless signal containing the ID code contained in the wireless signal received at the receiver. Accordingly, in a lighting system having a plurality of lighting fixtures installed in a large space that a wireless signal of one switch device cannot cover, light control can be performed for a lighting fixture that the wireless signal of the switch device cannot reach.

Preferably, the switch device is configured as a device incorporating the energy self-supplying unit in a portable-size casing and provided with the switch button on the surface of the casing. Accordingly, it is possible to transmit an instruction for light control from anywhere in the space in which the lighting system has been installed.

As described above, the present invention brings about an effect of allowing light control of a plurality of LED lamps to be performed merely by providing a relatively simple circuit in a lighting system in which the plurality of LED lamps are used and controlled by a wireless switch.

### BRIEF DESCRIPTION OF THE DRAWINGS

FIG. 1 is a schematic diagram showing a first embodiment of a lighting system to which the present invention has been applied;

FIG. 2 is a block diagram showing a circuit configuration example of a power control device for an LED lamp in the lighting system of the first embodiment;

FIG. 3 is a schematic view showing a relationship between a counted value (counter value) of a counter circuit and LED illuminance in a case where illuminance of the LED lamp is changed by a first control method in the lighting system of the first embodiment;

FIG. 4A is a cross-sectional view showing an internal configuration of the LED lamp in a case of applying a second control method in the lighting system of the first embodiment;

FIG. 4B is a schematic view showing a relationship between a counted value (counter value) of the counter circuit and emission colors of LEDs;

FIG. 5A is a schematic view showing an arrangement example of the LED lamps in a case of applying a third control method in the lighting system of the first embodiment;

FIG. 5B is a schematic view showing a relationship between a counted value (counter value) of the counter circuit and areas of the LED lamps to be lit;

FIG. 6 is a block diagram showing a configuration example of a sub power system circuit of a power control device in the lighting system as a modification example of the first embodiment;

FIG. 7 is a schematic view showing an arrangement example of the LED lamps and a relationship with wireless switches in the lighting system of a second embodiment;

FIG. 8 is a schematic view showing an arrangement example of the LED lamps and a relationship with wireless switches in the lighting system as a modification example of the second embodiment;

FIG. 9 is a schematic diagram showing an example of a conventional lighting system;

FIG. 10 is a schematic view showing a relationship between operations of the wireless switch and brightness of the LED lamp in a third embodiment;

FIG. 11 is a block diagram showing a configuration example of hardware on an LED power unit side in the third embodiment;

FIG. 12 is a schematic view showing a relationship between operations of the wireless switch in different timing and brightness of the LED lamp in the third embodiment;

FIG. 13 is a schematic view showing a relationship between operations of the wireless switch and brightness of the LED lamp in a first modification example of the third embodiment;

FIG. 14 is a block diagram showing a configuration example of hardware on the LED power unit side in the first modification example of the third embodiment;

FIG. 15 is a block diagram showing a configuration example of hardware on the LED power unit side in a second modification example of the third embodiment; and

FIG. 16 is a flowchart showing an example of a procedure of light control processing by a CPU in the second modification example of the third embodiment.

### DETAILED DESCRIPTION OF PREFERRED EMBODIMENTS

Hereinafter, preferred embodiments of the present invention will be described below with reference to the accompanying drawings.

### First Embodiment

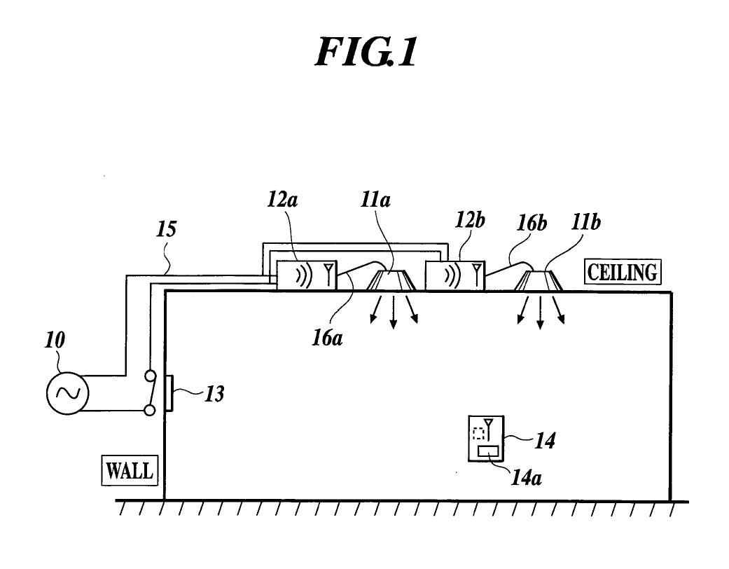

FIG. 1 shows a first embodiment of a lighting system according to the present invention in which a plurality of LED lamps are used and controlled by a wireless switch.

A lighting system of the present embodiment includes LED lamps 11a, 11b . . . as lighting fixtures attached to the ceiling of a building to be directed downward, LED power units 12a, 12b . . . each provided for each lamp to supply power to it, a main power switch 13 to turn on and off the power of the entire lighting system, and a wireless switch 14 transmitting a wireless signal for light control to the LED power units 12a, 12b . . . , and power wiring 15 supplying AC power supply voltage from a common AC power supply 10 to the LED power units 12a, 12b . . . is installed behind the ceiling from the inside of the wall of the building, as shown in FIG. 1. The LED power units 12a, 12b . . . and the corresponding LED lamps 11a, 11b . . . are connected via cables 16a, 16b . . . .

The wireless switch 14 is a kind of remote control, is equipped with a switch button 14a on the surface of a portable-size (palm-size) casing, and incorporates an electromechanical transducer as a power generator generating power through the use of movement by an operation of the switch button 14a and a transmitter outputting a wireless signal (radio wave) such as a 2.4 GHz signal. Since the energy self-supplying type wireless switch that does not require a battery having such structure and function is conventionally known in various configuration types, its detailed description will be omitted.

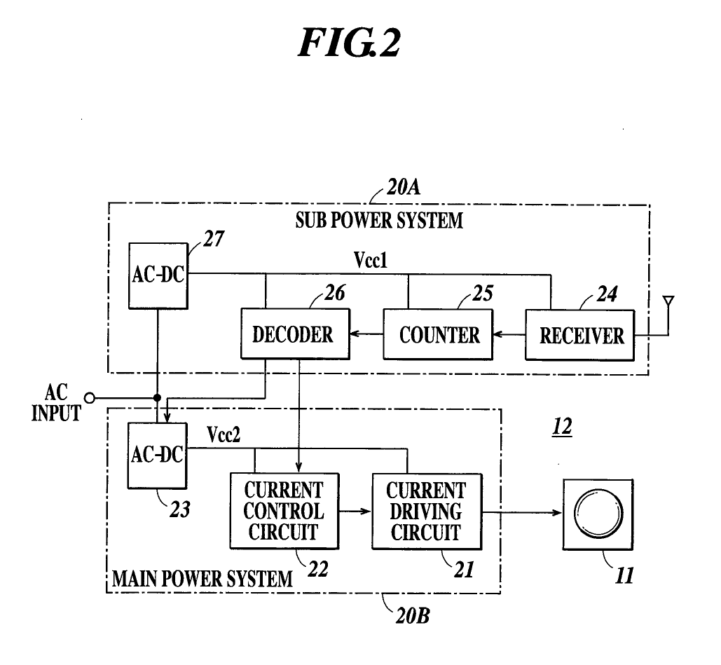

FIG. 2 shows a configuration example of the LED power unit 12 constituting the lighting system.

The LED power unit 12 in FIG. 2 includes a current driving circuit (current source) 21 outputting driving current to drive the LED lamp with constant current, a current control circuit 22 controlling the current driving circuit 21 to change the magnitude of current to be flown into the LED lamp, and an AC-DC converting circuit 23 as a main power supply receiving AC power and generating direct-current power supply voltage Vcc2 required for operations of the aforementioned current driving circuit 21 and current control circuit 22.

The LED power unit 12 also includes a receiver 24 receiving a wireless signal from the wireless switch 14, a counter circuit 25 counting the number of pulse signals from the receiver 24, a decoder circuit 26 decoding an output (counted value) of the counter circuit 25, and an AC-DC converting circuit 27 as a sub power supply receiving AC power and generating direct-current power supply voltage Vcc1 required for operations of the aforementioned receiver 24, counter circuit 25, and decoder circuit 26.

The receiver 24 is configured to output a one-shot pulse signal when it receives a wireless signal from the wireless switch 14. The counter circuit 25 is composed of 3 bits, for example, and is configured to increment the counted value by one each time the pulse signal comes from the receiver 24 so that the maximum number of pulses to be counted may be 8.

The AC-DC converting circuit 27 as a sub power supply generating direct-current power supply voltage Vcc1 required for operations of the receiver 24, counter circuit 25, and decoder circuit 26 converts AC voltage into direct-current voltage at all times. On the other hand, the AC-DC converting circuit 23 as a main power supply generating direct-current power supply voltage Vcc2 required for operations of the current driving circuit 21 and current control circuit 22 is configured to stop to convert AC voltage into direct-current voltage while the LED lamp is off.

Specifically, when a pulse signal comes from the receiver 24 while the LED is off, for example, the AC-DC converting circuit 23 as a main power supply is activated, and the current driving circuit 21 and the current control circuit 22 are ready to be operated. Also, when driving current output from the current control circuit 22 becomes zero to cause the LED to be switched to an off state, the AC-DC converting circuit 23 as a main power supply is adapted to be off.

As described above, since the main power supply is off while the LED lamp is off, the power consumption (standby power consumption) of the LED power unit 12 can be low. Also, in the present embodiment, since a wireless signal containing a command code does not need to be transmitted from the wireless switch 14, the configuration of the circuit on the wireless switch 14 side is simple. Further, since the energy to be generated or the moving distance of the switch button can be small in a case where a switch device incorporating an energy self-supplying unit is used as the wireless switch, the switch device can be reduced in size or thickness. Still further, a CPU to decode a command code is not needed on the power unit 12 side, which is advantageous in terms of simplification of the circuit. It is noted that, in FIG. 2, the power unit 12 includes a first circuit section 20A as a sub power system circuit, and a second circuit section 20B as a main power system circuit.

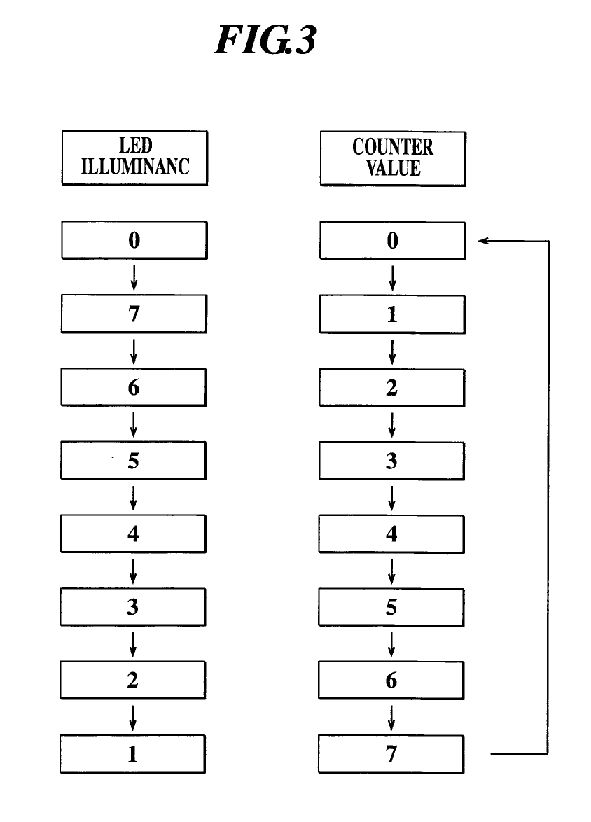

Next, operations of the receiver 24, counter circuit 25, and decoder circuit 26 in the first circuit section 20A operated by the sub power will be described with reference to FIGS. 3 to 5. For light control that can be done by the power unit configured as in FIG. 2, the three methods described below can be used.

A first control method is a control method in which the counted value of the counter circuit 25 is incremented each time the receiver 24 receives a wireless signal from the wireless switch 14, and brightness of the LED lamp 11 is changed according to the counted value. Also, a second control method is a control method in which the LED lamp 11 is configured as a lighting fixture incorporating three-color LEDs consisting of a red LED, a blue LED, and a green LED, the counted value of the counter circuit 25 is incremented each time the receiver 24 receives a wireless signal from the wireless switch 14, and the emission color of the LED lamp 11 is changed according to the counted value. A third control method is a control method to change an area to be lit.

FIG. 3 shows a relationship between a counted value (counter value) of the counter circuit 25 and LED illuminance in a case where brightness or illuminance of the LED lamp 11 is changed by the first control method. It is noted that, in FIG. 3, a higher number among the numbers “1” to “7” representing illuminance expresses a brighter state while a lower number expresses a darker state, and “0” expresses a turning-off state. The more the current flows, the more brightly the LED lamp emits light, which means that the larger the value of a number representing illuminance in FIG. 3 is, the more the LED driving current is output from the current driving circuit 21.

In the control method in FIG. 3, the value of the counter circuit 25 and the value representing illuminance change in a reverse order. That is, as the value of the counter circuit 25 is larger in the order starting from “1,” and as the value representing illuminance is smaller in the order starting from “7,” the amount of the output current is decreased. Also, in a case where a signal comes from the wireless switch 14 when the value of the counter circuit 25 is “7” (the value representing illuminance is “1”), the counted value returns to “0,” and the lamp is controlled to be turned off. The counter circuit 25 may be a down counter instead of the up counter.

In a case where the first control method is applied to the lighting system in FIG. 1, the power units 12 of the plurality of lamps receive signals from the wireless switch 14 simultaneously, the respective counter circuits 25 and decoder circuits 26 are operated in the same manner, and thus illuminance of all the LED lamps 11 is controlled to be changed in the same order at a time. According to FIG. 3, when a first wireless signal comes from the wireless switch 14, all the LED lamps 11a, 11b . . . are lit at the highest illuminance level, and thereafter the illuminance level is controlled to be lowered by one each time the wireless signal comes.

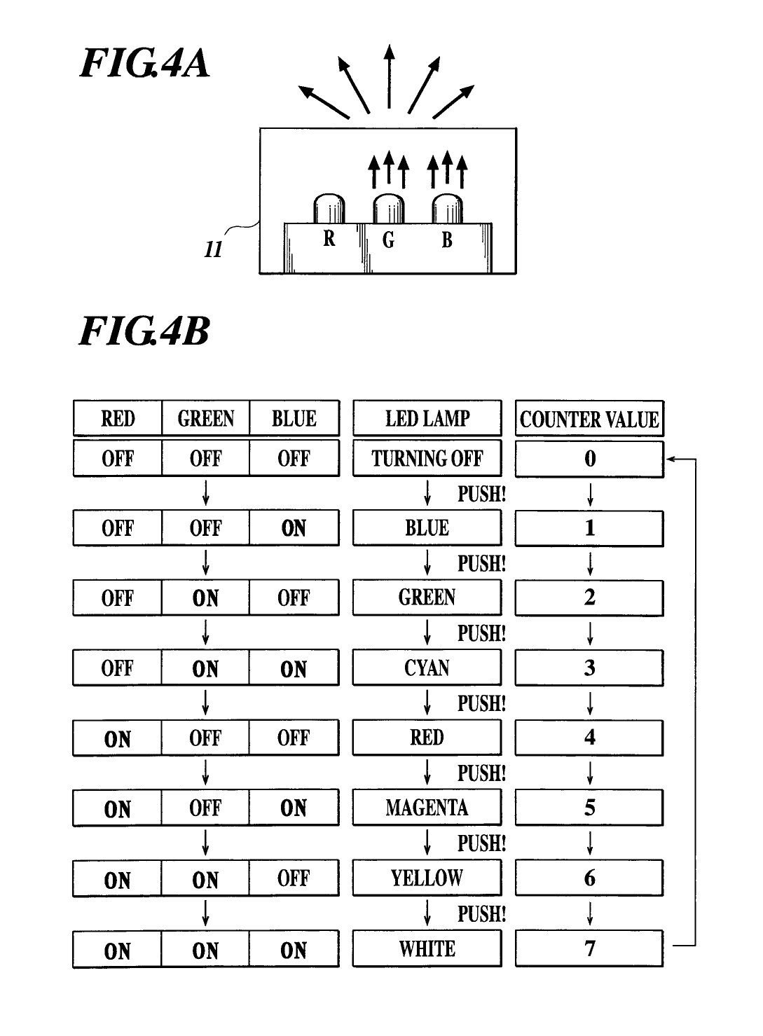

FIG. 4B shows a relationship among a counted value of the counter circuit 25, LEDs to be lit, and an emission color in a case where the emission color of the LED lamp 11 is changed by the second control method. As shown in FIG. 4B, the value of the counter circuit 25 is incremented from “1” to “7” each time a reception signal comes. When the counted value is “1,” only the blue LED is turned on. When the counted value is “2,” only the green LED is turned on. When the counted value is “3,” the blue LED and the green LED are turned on, and the emission color is “cyan.” It is noted that the relationship between the value of the counter circuit 25 and the emission color is not limited to one shown in FIG. 4B, but the order may be reversed. Also, the counter circuit 25 may be a down counter instead of the up counter.

In a case where the second control method is applied to the lighting system in FIG. 1, the power units 12 of the plurality of lamps receive signals from the wireless switch 14 simultaneously, the respective counter circuits 25 and decoder circuits 26 are operated in the same manner, and thus all the LED lamps 11 are controlled to be lit in the same emission color at a time. According to FIG. 3, when a first wireless signal comes from the wireless switch 14, all the LED lamps 11a, 11b . . . are lit in blue, and thereafter the emission color is controlled to be changed in the order of “green,” “cyan,” “red,” “magenta,” “yellow,” and “white” each time the wireless signal comes.

With the lighting system to which this second control method has been applied, changing lighting depending on the difference of displayed products such as the difference between those in a sales floor for food and those in a sales floor for clothing or the difference between day and night in a store or changing lighting depending on the difference of exhibits or exhibition contents in an event site enables more impressive display or exhibit. It is noted that each of the LED lamps 11a, 11b . . . is set to have a different emission color changing order.

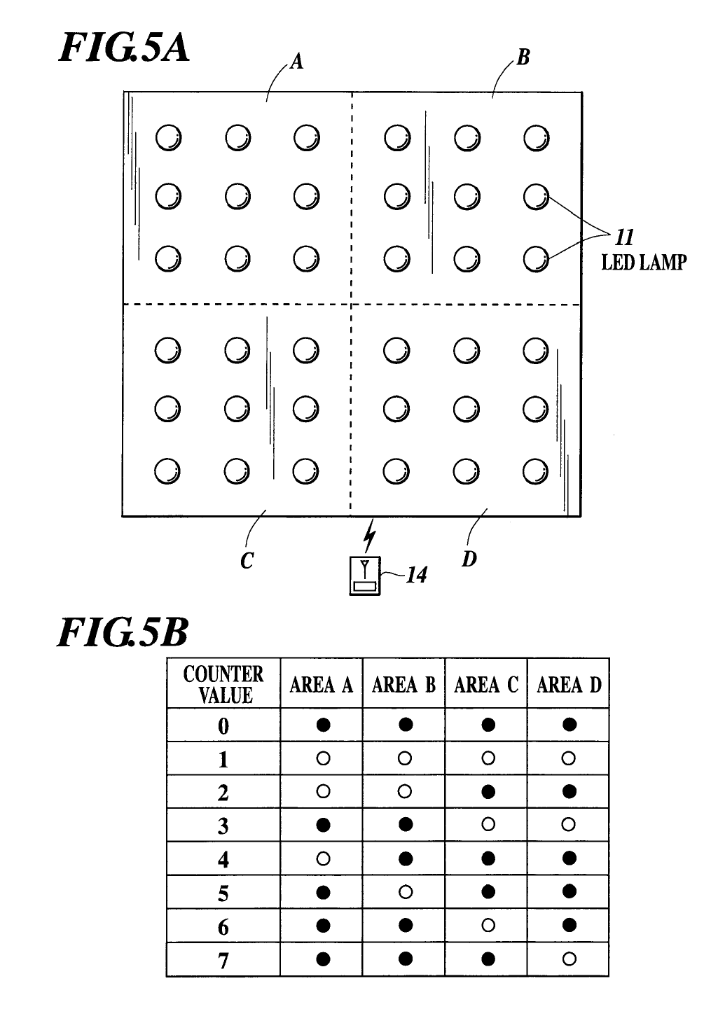

FIGS. 5A and 5B schematically show the lighting system to which the third control method has been applied. This lighting system to which the third control method has been applied uses a control method suitable for a relatively large building in which multiple LED lamps 11 can be provided as shown in FIG. 5A. In this lighting system, a space is divided into 4 areas A, B, C, and D and is provided with 36 LED lamps 11 in total with each area provided with 9 lamps.

Turning-on areas of these LED lamps 11 are controlled according to the counter value of each corresponding LED power unit that is changed by a wireless signal from the wireless switch 14 in such a manner as “turning-on in all of the 4 areas”—“turning-on in areas A and B”—“turning-on in areas C and D”—“turning-on only in area A”—“turning-on only in area B”—“turning-on only in area C”—“turning-on only in area D.”

The above control can be done by changing per area the configuration of the decoder circuit decoding the value of the counter circuit in each LED power unit 12 shown in FIG. 2. Specifically, as shown in FIG. 5B, all that is required is to configure the decoder circuits of the power units in each area so that the lamps to be controlled may be controlled to be in an on state or off state according to the counter values of the counter circuits 25. Meanwhile, the black circle represents a turning-off state while the white circle represents a turning-on state in FIG. 5.

### MODIFICATION EXAMPLE

Next, a modification example of the lighting system of the above embodiment is shown. In this modification example, control by the aforementioned third control method or control by the aforementioned first control method is done according to a wireless signal from one wireless switch. Specifically, when a wireless signal from the wireless switch 14 comes to the LED power units 12 in an off state, turning-on areas of the lamps are first switched according to the number of signals (counter value) or the number of times of pressing the wireless switch as shown in FIG. 5. Subsequently, when a wireless signal comes to the LED power units 12 again after a lapse of a predetermined period of time, illuminance of the lamps in each area in which the turning-on state has been fixed is controlled to be changed according to the number of wireless signals (counter value) or the number of times of pressing the wireless switch as shown in FIG. 3.

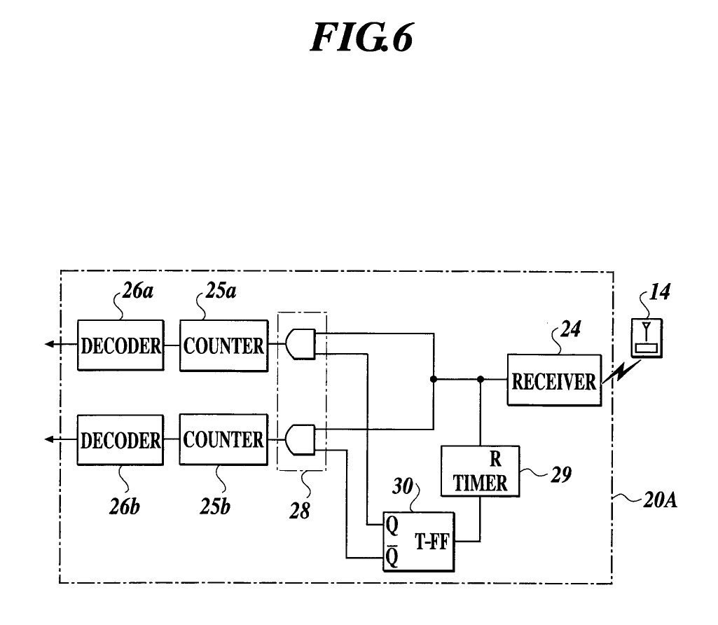

FIG. 6 shows a configuration example of the sub power system circuit 20A of the LED power unit 12 that can perform the control as described above. The main power system circuit 20B can be the same as that shown in FIG. 2 and thus is not shown in the figure. As shown in FIG. 6, the sub power system circuit 20A of the LED power unit 12 in this modification example is provided with two counter circuits 25a, 25b each counting the number of wireless signals from the wireless switch 14 and two decoder circuits 26a, 26b. The counter circuit 25a and the decoder circuit 26a are operated to determine areas to be lit while the counter circuit 25b and the decoder circuit 26b are operated to determine illuminance (brightness) of the lamps that are lit.

Also, on the pre-stage of the counter circuits 25a, 25b are provided a selector 28 selectively inputting a pulse signal from the receiver 24 in either the counter circuit 25a or the counter circuit 25b, a timer circuit 29 measuring an interval of pulses, and a toggle type flip-flop (T-FF) 30 in which the output is in a high level and a low level alternately in response to a signal (pulse) from the timer circuit 29.

In a case where no pulse comes to the timer circuit 29 from the receiver 24 in a predetermined period of time (e.g., 2 to 5 seconds), the timer circuit 29 is adapted to output a pulse to the post-stage T flip-flop 30. Also, since the output state of the T flip-flop 30 is inversed per incoming pulse, the T flip-flop 30 controls the selector 28 to input a pulse from the receiver 24 in the counter circuit 25a or 25b depending on the output state of the T-FF.

Accordingly, in this modification example, when a user operates the wireless switch 14 in a state where all of the lamps are off, a pulse from the receiver 24 is first supplied to the counter circuit 25a. The lamps in all areas are turned on in the first operation, and areas to be lit are sequentially switched by continuous operations in a predetermined interval period. Subsequently, when the user once stops operations of the wireless switch 14 in a state where desired areas are lit and continuously operates the wireless switch 14 again after a lapse of the predetermined interval period, the timer circuit 29 outputs a pulse by detecting the predetermined period, the output state of the T flip-flop 30 is inversed by the pulse, and the T flip-flop 30 switches the selector 28 to a side on which a pulse from the receiver 24 is input in the counter circuit 25b. In this state, brightness is changed in incremental levels according to the number of times of switch operations.

When the user stops operations of the wireless switch 14 at a desired brightness level, the illuminance is fixed at the brightness level. Subsequently, when the timer circuit 29 outputs a pulse by detecting the predetermined period, the output state of the T flip-flop 30 is inversed by the pulse, and the T flip-flop 30 switches the selector 28 to a side on which a pulse from the receiver 24 is input in the counter circuit 25a. Thus, when the user thereafter operates the wireless switch 14 again, the user can switch a turning-on state of lamps (areas). When the user stops operations at the time the value of the counter circuit 25a returns to “0” after several times of switch operations, the user can set a state where all of the lamps are turned off.

### Second Embodiment

Next, a second embodiment of the lighting system according to the present invention will be described.

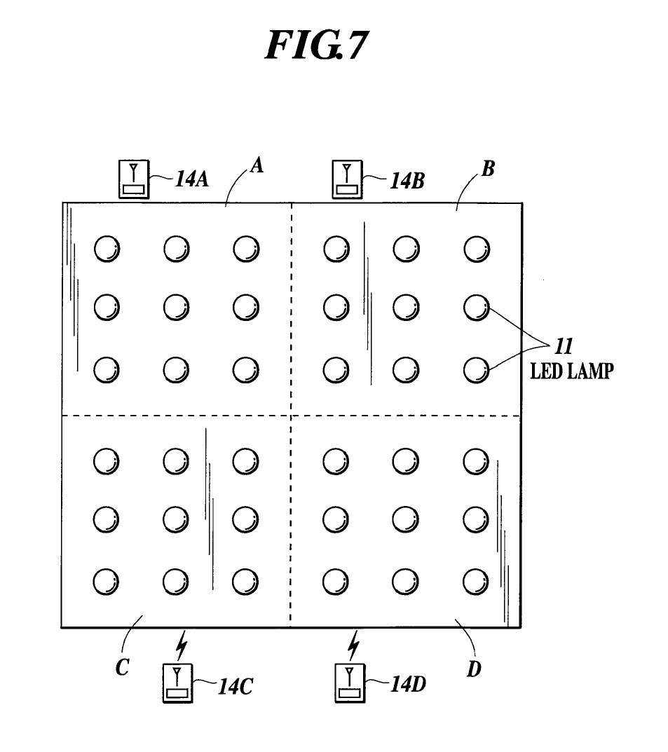

The lighting system of the second embodiment is configured to be capable of performing light control by using a plurality of wireless switches each transmitting a unique ID code (identification code). For brightness control, the first control method (refer to FIG. 3) described in the above first embodiment is applied. FIG. 7 shows an example of the lighting system of the second embodiment.

As shown in FIG. 7, in the lighting system of the present embodiment, a space is divided into 4 areas A, B, C, and D and is provided with 36 LED lamps 11 in total with each area provided with 9 lamps, in the same manner as that of the lighting system in FIG. 5A. The lighting system of the present embodiment differs with the embodiment in FIG. 5 in that wireless switches 14A, 14B, 14C, 14D, corresponding to the respective areas A, B, C, D, each transmitting a unique ID code are provided so that light control can be done by the plurality of wireless switches.

Each of the wireless switches 14A, 14B, 14C, 14D is given a unique ID code and is configured to transmit a wireless signal with the ID code. The LED power unit (not shown) provided to correspond to each LED lamp 11 includes the sub power system circuit and the main power system circuit in the same manner as one shown in FIG. 2, and the sub power system circuit includes a storage unit having stored therein a predetermined ID code in advance and a unit or a circuit such as a CPU having a function of extracting an ID code contained in a signal received at the receiver and a function of determining whether or not the extracted ID code corresponds to the ID code stored in the storage unit.

In the embodiment in FIG. 7, the LED power units corresponding to the LED lamps 11 in area A store the same code as an ID code given to the wireless switch 14A, and the LED power units corresponding to the LED lamps 11 in area B store the same code as an ID code given to the wireless switch 14B. Similarly, the LED power units in area C store an ID code of the wireless switch 14C, and the LED power units in area D store an ID code of the wireless switch 14D.

Light control in the lighting system of the present embodiment is done in the following manner. For example, when a user operates the wireless switch 14A, only the LED power units corresponding to the LED lamps 11 in area A respond to it, and the value of each internal counter is changed according to the number of times of pressing the wireless switch 14A, as shown in FIG. 3. Then, the driving current controlled to let illuminance of the LED changed according to the counter value is output from the current driving circuit 21 (FIG. 2) to the LED lamp. By doing so, only the LED lamps 11 in area A are controlled.

Also, when the user operates the wireless switch 14B, only the LED power units corresponding to the LED lamps 11 in area B respond to it, the driving current for the LEDs is output, and only the LED lamps 11 in area B are controlled. Similarly, when the user operates the wireless switch 14C, only the LED lamps 11 in area C are controlled, and when the user operates the wireless switch 14D, only the LED lamps 11 in area D are controlled.

### MODIFICATION EXAMPLE

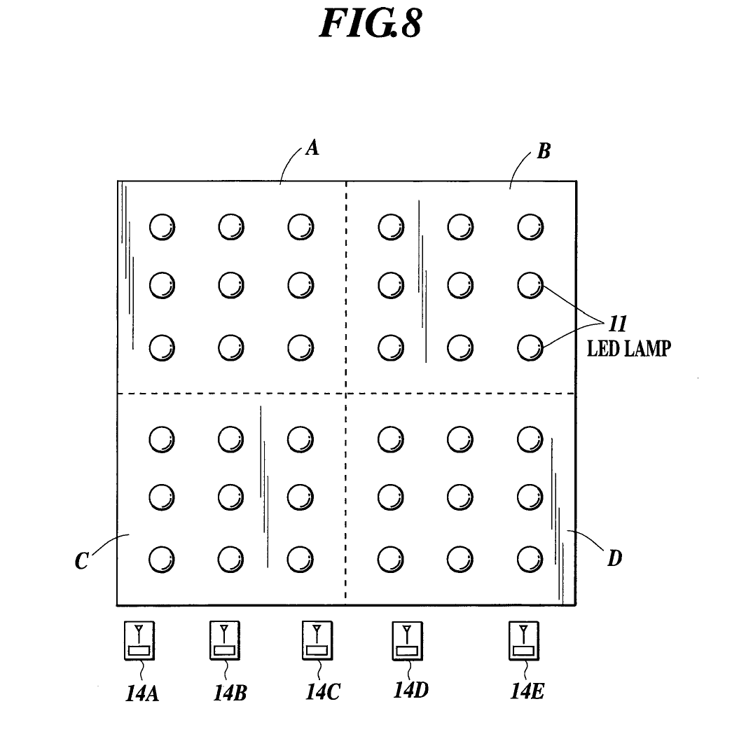

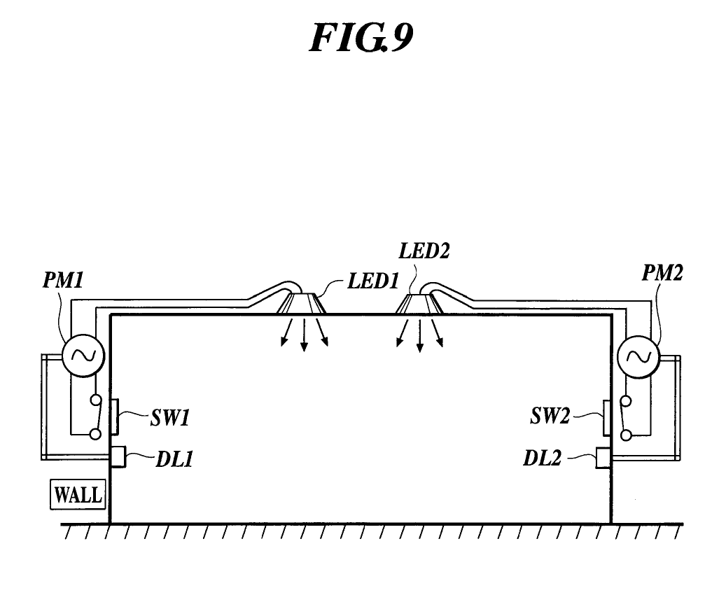

FIG. 8 shows a modification example of the lighting system of the second embodiment.

In this modification example, a common wireless switch 14E having a unique ID code is further added to the lighting system in FIG. 7, and each of the LED power units corresponding to each LED lamp 11 has stored therein the ID code of the common wireless switch 14E as well as the ID code of the corresponding wireless switch. Each LED power unit is configured to turn on or off the corresponding LED lamp when it receives the ID code of the common wireless switch 14E. Accordingly, in the lighting system of this modification example, when the user operates the common wireless switch 14E, the LED lamps in all areas A, B, C, D are controlled to be turned on or off at a time.

In the lighting system as the modification example, it is preferable to provide the receiver 24 (refer to FIG. 2) of each LED power unit with a transmission function so that the receiver 24 may transmit a received signal to the receivers 24 of other LED power units in the vicinity as it is. By such a configuration, even in a case where, in the large-scale lighting system installed in an extremely large building, a user operates any one of the wireless switches in the corner of the room, and thus radio wave does not reach all of the LED power units, an ID code received by any one of the LED power units will be transmitted in order in a relay system. As a result, even in a case where the user operates the wireless switch 14A for area A in area D, in which radio wave from the wireless switch 14A is hard to reach area A, the user can control only the LED lamps in area A.

Also, each LED power unit may be provided with a transmission function in its receiver 24 so as to inform the LED power units in other areas of a light control state in its own area. In this configuration, in a case where, when the common wireless switch 14E is operated, the LEDs in its own area are in an off state while the LEDs in any of the other areas are in an on state, the LED power unit keeps its own LED off. In a case where, when the common wireless switch 14E is operated, the LEDs in all areas including its own area are in an off state, the LED power unit lets its own LED turned on while the LED power units in the other areas control their own LEDs in a similar manner. This can provide the common wireless switch 14E with a function as a main power switch.

Although the invention made by the present inventors has been described above specifically based on the embodiments, the present invention is not limited to the above embodiments. For example, although the LED power unit 12 constituting the lighting system of each of the above embodiments includes the counter circuit 25 counting the number of times of pressing the wireless switch 14 and the decoder circuit 26 decoding the counted value, it may include instead of the counter circuit and the decoder circuit a sequential circuit configured to have a toggle type flip-flop inversing the output state per incoming signal from the wireless switch so that the flip-flop may output signals that cause the magnitude of output driving current to be changed sequentially, that is, signals corresponding to outputs of the aforementioned decoder, as a result of a change in the internal logic state by each change of the output of the flip-flop.

Also, in the lighting system of the second embodiment in FIG. 7 or 8, each of the plurality of wireless switches is configured to correspond to the LED lamps provided in each area. However, the wireless switches may be configured to perform light control per group by assigning consecutive numbers to the respective LED lamps and letting the respective wireless switches correspond to the LED lamps to which numbers 4n+1, 4n+2, 4n+3, 4n (n is a positive integer including 0) have been assigned in a case where the number of the wireless switches is 4, for example.

The LED lamps may be grouped so that some LED lamps may belong to plural groups, instead of the above nonredundant grouping. Such grouping that allows redundancy can be obtained easily by storing plural ID codes in each LED power unit. By doing so, control to change brightness depending on the number of lamps to be lit can be done.

Further, in the above embodiments, the wireless switch is configured as a remote control device. However, particularly in a case where the power unit incorporates a transmitter to allow two-way transmission as described in the second embodiment, the plurality of wireless switches may be put together and arranged at one location such as on a wall near a door as a fixed-type switch device.

Still further, the wireless switch may transmit a command code as well as the ID code, and the power unit may be provided with a function to decode the command code. This allows further complicated control such as direct turning on and off, without light control operations, of LED lamps in desired areas or some specified LED lamps among plural LED lamps, setting desired illuminance, and setting desired color tone. Each of these control operations may be done by each individual wireless switch, or several control operations may be done by one wireless switch. Also, the wireless switch 14 is not limited to an energy self-supplying type but may be one operated by a battery (small battery) depending on the embodiment.

### Third Embodiment

Next, a third embodiment of the lighting system according to the present invention will be described.

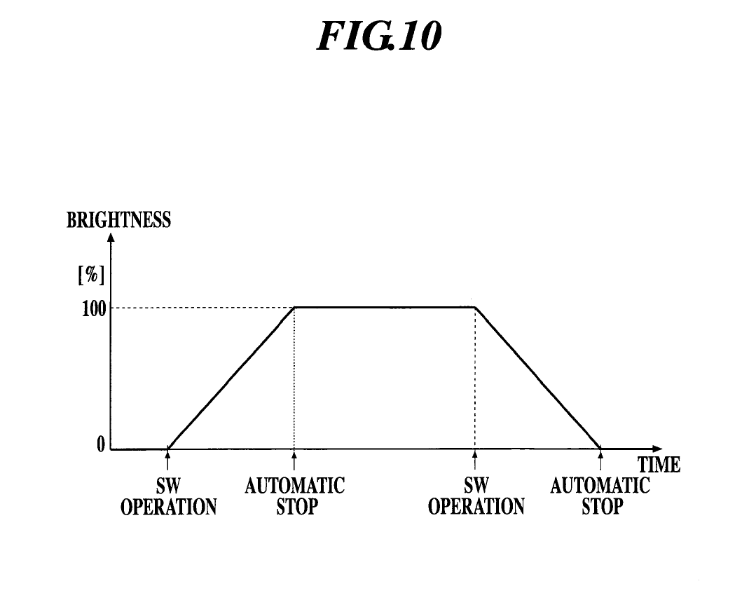

The lighting system of the third embodiment is configured to have a fade-in and fade-out light control function in which the LED lamps automatically get brighter or darker by an operation of the wireless switch. Specifically, the LED power unit 12 is configured to make the following operations possible. As shown in FIG. 10, when the wireless switch is operated once, the LED lamps gradually get brighter. When the brightness reaches 100%, the state is maintained. When the wireless switch is operated again, the LED lamps gradually get darker.

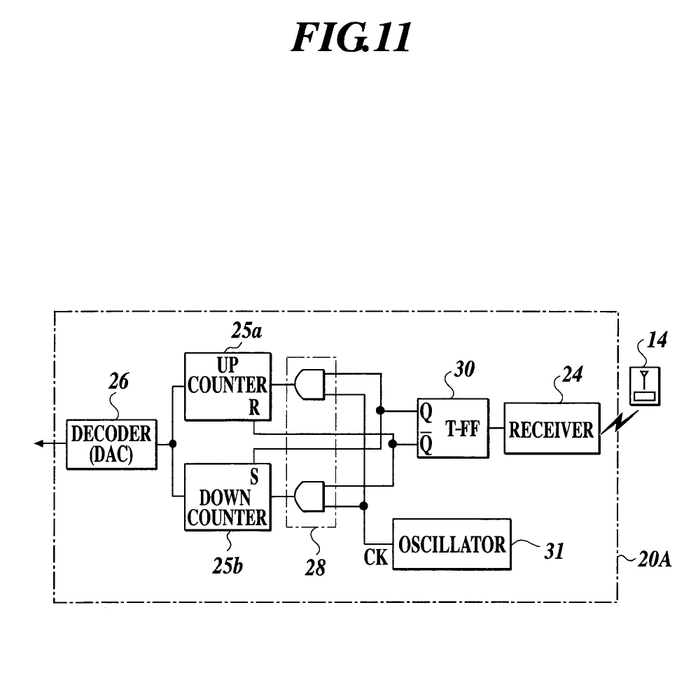

FIG. 11 shows a configuration example of the sub power system circuit 20A of the LED power unit 12 capable of performing the light control as described above. The main power system circuit 20B can be the same as that shown in FIG. 2 and thus is not shown in the figure.

As shown in FIG. 11, the sub power system circuit 20A of the LED power unit 12 of the present embodiment is provided with a receiver 24 receiving a wireless signal from the wireless switch 14, an oscillator 31 generating clock signals CK having a predetermined frequency, an up counter circuit 25a and a down counter circuit 25b each counting the number of clock signals, and a decoder circuit 26 as a conversion circuit decoding these counter values. The up counter circuit 25a is used for light control of making the LED lamps gradually brighter while the down counter circuit 25b is used for light control of making the LED lamps gradually darker. A DA converter (DAC) may be used instead of the decoder circuit 26. In the case of using the DAC, the current control circuit 22 may be omitted, and the current driving circuit 21 may be controlled by an output of the DAC, depending on the circuit form.

Also, the sub power system circuit 20A is also provided on the pre-stage of the counter circuits 25a, 25b with a selector 28 selectively inputting clock signals CK from the oscillator 31 in either the counter circuit 25a or the counter circuit 25b and a toggle type flip-flop (T-FF) 30 in which the output is in a high level and a low level alternately in response to a pulse output per reception of a wireless signal from the wireless switch 14 at the receiver 24.

Since the output state of the T flip-flop 30 is inversed per incoming pulse, the T flip-flop 30 controls the selector 28 to input clock signals CK from the oscillator 31 in the counter circuit 25a or 25b depending on the output state of the T-FF. Also, the up counter circuit 25a and the down counter circuit 25b are configured so that, when they have counted to the maximum value and the minimum value, respectively, they may not change the counted value any more even when another clock signal comes. When the output state of the T flip-flop 30 is inversed to cause Q to be in a high level, the value of the down counter circuit 25b is set to the maximum value, and when the output state of the T flip-flop 30 is inversed to cause /Q to be in a high level, the value of the up counter circuit 25a is reset to the minimum value.

In the present embodiment, the up counter circuit 25a and the down counter circuit 25b are composed of 8 bits, for example, to allow control of the LED lamps so that their brightness may gradually change in 256 steps.

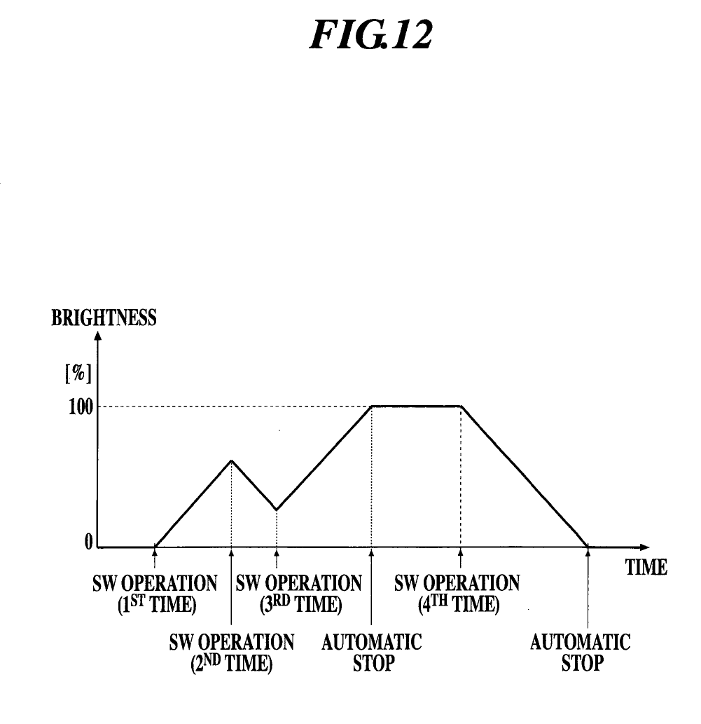

Also, in a case where the sub power system circuit 20A of the LED power unit 12 is configured as shown in FIG. 11, the following light control can be done. For example, as shown in FIG. 12, the up counter circuit 25a is operated by a first wireless switch operation, and brightness of the LED lamps is gradually raised. When the wireless switch is operated again during the gradual brightness rise, the down counter circuit 25b is operated, and brightness of the LED lamps is gradually lowered. When the wireless switch is operated yet again, the up counter circuit 25a is operated, and brightness of the LED lamps is gradually raised.

### Modification Example 1

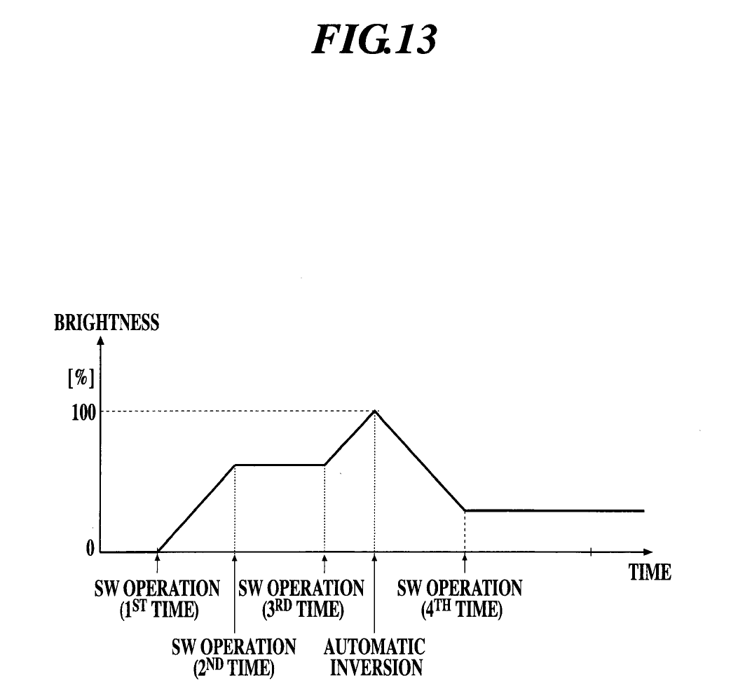

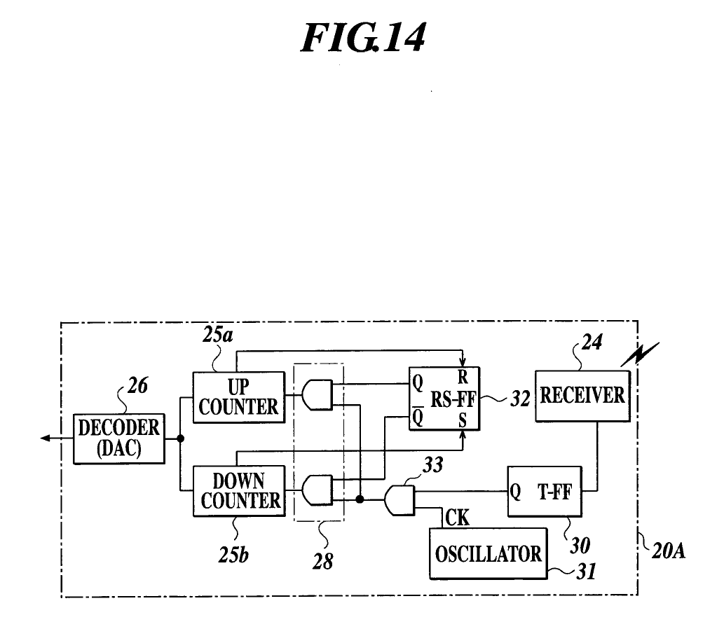

FIGS. 13 and 14 show a first modification example of the third embodiment of the lighting system according to the present invention. According to this modification example, changes in brightness can be stopped by operating the wireless switch while the brightness of the LED lamps is changing.

Specifically, the following light control can be done. As shown in FIG. 13, when the wireless switch is operated first, brightness of the LED lamps is gradually raised. When the wireless switch is operated again during that period, the brightness of the LED lamps is maintained. When the wireless switch is operated yet again, brightness of the LED lamps is gradually raised again. When the brightness reaches 100%, brightness of the LED lamps is gradually lowered.

The above control can be done by configuring the sub power system circuit 20A of the LED power unit 12 as shown in FIG. 14, for example.

The sub power system circuit 20A in FIG. 14 is similar to the sub power system circuit 20A in FIG. 11. They are different in that the sub power system circuit 20A in FIG. 14 is provided with an RS flip-flop (RS-FF) 32 and an AND gate 33 controlling supply of the clock signals CK in addition to the T flip-flop (T-FF) 30 in which the output state is inversed each time the receiver 24 receives a wireless signal from the wireless switch 14, and in that the AND gate 33 is controlled by an output of the T-FF 30 so that the clock signals CK may pass and be blocked alternately per reception of the wireless signal.

In the present modification example, the up counter circuit 25a and the down counter circuit 25b supply the RS-FF 32 with signals showing whether or not the values have reached the maximum value and the minimum value, respectively. The RS-FF 32 is in a reset state by the signal output when the up counter circuit 25a has reached the maximum value and is in a set state by the signal output when the down counter circuit 25b has reached the minimum value. The selector 28 is adapted to be controlled by an output of the RS-FF 32. When the up counter circuit 25a has reached the maximum value to cause brightness to be 100%, the clock signals CK are supplied to the down counter circuit 25b. Also, when the down counter circuit 25b has reached the minimum value to cause brightness to be 0%, the clock signals CK are supplied to the up counter circuit 25a. In this manner, the light control operations as shown in FIG. 13 can be done.

### Modification Example 2

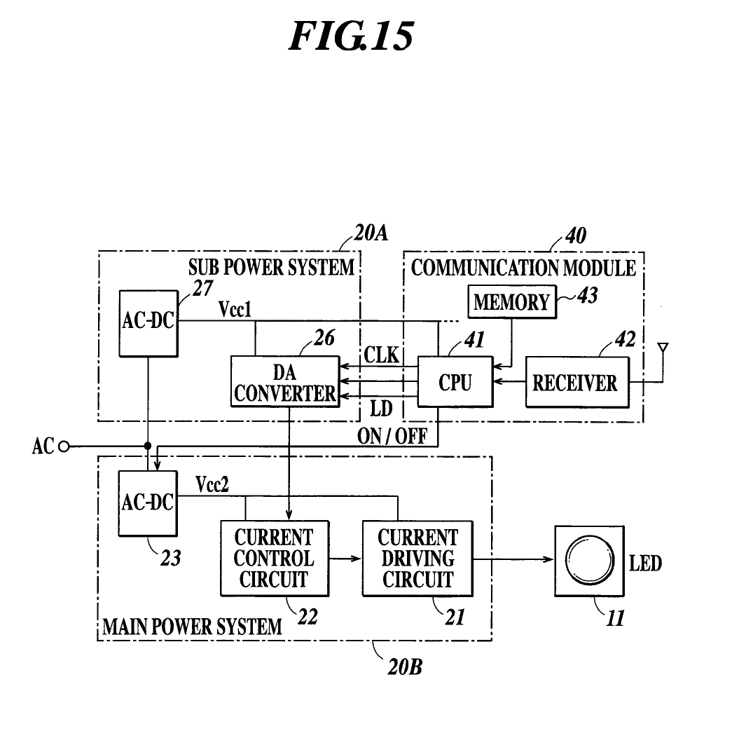

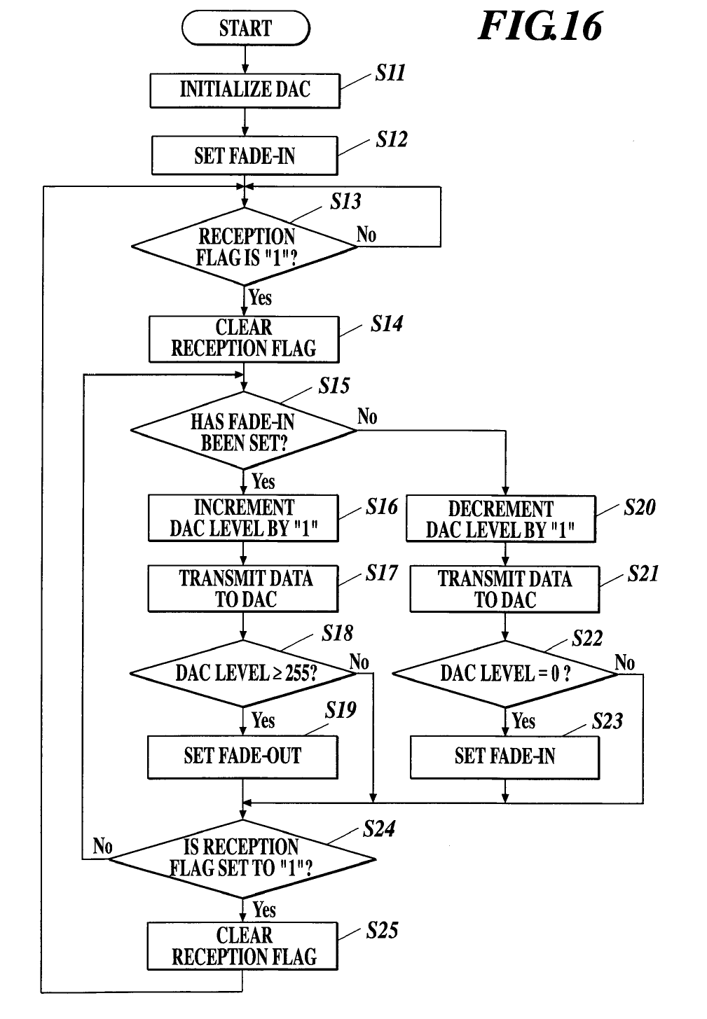

FIGS. 15 and 16 show a second modification example of the third embodiment of the lighting system according to the present invention. In this modification example, the light control shown in FIG. 13 is done by a CPU (micro computer) program control.

FIG. 15 shows a configuration example of hardware on the LED power unit 12 side in this modification example.

As shown in FIG. 15, this modification example is provided on the LED power unit 12 side with a communication module 40 having a CPU 41, a receiver 42, and a memory 43 constituted by a RAM (random access memory), a ROM (read only memory), etc. in addition to the sub power system circuit 20A and the main power system circuit 20B. The communication module 40 can be regarded as one contained in the sub power system circuit by being configured to be operated by supply of direct current from the AC-DC converter 27.

This modification example is also provided in the sub power system circuit 20A with a DA converter (DAC) 26 as a conversion circuit converting data showing a brightness level transmitted from the CPU 41 into a voltage value or a current value. From the CPU 41 to the DA converter 26 are transmitted operation clock signals CLK for the DAC, data showing a brightness level, and a signal LD showing a valid duration of data or acquisition timing of data. From the CPU 41 to the main power system circuit 20B (AC-DC converter 23) is transmitted a signal ON/OFF instructing on/off of the power or turning on/off of the LEDs.

Next, the light control by the above CPU 41 will be described. FIG. 16 shows an example of a flowchart showing a procedure of the light control processing by the CPU 41. The light control processing is done by execution by the CPU 41 of a control program according to this flowchart stored in the memory 43 in the communication module 40 or a ROM in the CPU 41.

The light control processing in the present modification example is done in the following manner. As shown in FIG. 16, a DAC input level of the DA converter (DAC) 26 is initialized or is set to “0” (Step S11). Subsequently, an internal processing state is set to “fade-in” (Step S12), and it is determined whether or not a reception flag showing whether or not a signal from the wireless switch has been received is “1” (Step S13). The reception flag “0” represents that no signal is received from the wireless switch while the reception flag “1” represents that a signal has been received from the wireless switch. When it has been determined in Step S13 that the reception flag is not “1” (No), Step S13 is repeated until the reception flag becomes “1.”

When it has been determined in Step S13 that the reception flag is “1” (Yes), the processing goes to Step 514, the reception flag is cleared (Step S14), and then it is determined whether or not the internal processing state is set to “fade-in” (Step S15). When it has been determined in Step S15 that “fade-in” is set (Yes), the processing goes to Step S16, the DAC input level showing a DAC input value or an LED brightness level is “+1” (incremented), and the value is transmitted to the DAC as input data (Step S17). Accordingly, the CPU 41 executing the program according to the flowchart functions as a counter.

Next, it is determined whether or not the updated DAC input level reaches the maximum value, “255” (Step S18). When it has been determined that the DAC input level is not “255” (No), the processing jumps to Step S24. When it has been determined in Step S18 that the DAC input level is “255” (Yes), the processing goes to Step S19, the internal processing state is set to “fade-out,” and the processing goes to Step S24.

On the other hand, when it has been determined in Step S15 that “fade-in” is not set (No), the processing goes to Step S20, the DAC input level showing a DAC input value or an LED brightness level is “−1” (decremented), and the value is transmitted to the DAC as input data (Step S21).

Next, it is determined whether or not the updated DAC input level reaches the minimum value, “0” (Step S22). When it has been determined that the DAC input level is not “0” (No), the processing jumps to Step S24. When it has been determined in Step S22 that the DAC input level is “0” (Yes), the processing goes to Step S23, the internal processing state is set to “fade-in,” and the processing goes to Step S24.

In Step S24, it is determined whether or not the reception flag is “1,” that is, whether or not a signal has been received from the wireless switch again. When it has been determined that the reception flag is not “1” (No), the processing returns to Step 515, and the processing in Steps S15 to S23 is repeated. When it has been determined in Step S24 that the reception flag is “1” (Yes), the processing goes to Step S25, and the reception flag is cleared. Then, the processing returns to Step S13, and the processing in Steps S13 to S25 is repeated. By performing such processing according to the procedure, the light control shown in FIG. 13 can be done.

Meanwhile, although the flowchart to perform the light control shown in FIG. 13 by a program has been described in this second modification example, it is possible to configure the LED power unit 12 so that the light control shown in FIG. 10 or the light control shown in FIG. 12 can be performed by a program in a similar manner.

### Modification Example 3

In a third modification example of the third embodiment of the lighting system according to the present invention, each of plural wireless switches is given a different ID code and is configured to transmit a wireless signal with the ID code when its button is operated.

The LED power unit 12 in this modification example is configured to have hardware shown in FIG. 15, and programs executed by the CPU 41 are constructed to have light control functions according to several patterns or sequences such as a gradual illuminance control function as shown in FIG. 3 (Function #1), a simple fade-in and fade-out type light control function as shown in FIG. 10 or 12 (Function #2), and a fade-in and fade-out type light control function enabling an intermediate stop as shown in FIG. 13 (Function #3).

Also, in a ROM of a memory (e.g., 43) on the LED power unit 12 side is provided a function table storing the aforementioned functions #1 to #3 and the ID codes of the wireless switches by corresponding them to one another. When the CPU 41 receives an ID code from a wireless switch, it refers to the function table and executes light control corresponding to a function in which the ID code is registered.

In the lighting system using the LED power unit configured as above, the plural wireless switches having different ID codes are prepared, and when a user operates any one of the wireless switches, light control in which the lamps are lit in a different pattern depending on the operated wireless switch is performed. This is advantageous in that various light control patterns can be obtained at the user's desire. It is also advantageous in that the cost can be reduced since the only difference among the wireless switches is an ID code to be stored, and the same hardware configuration can be used for the wireless switches.

Although the various modification examples of the third embodiment have been described above, the present invention is not limited to the above examples of the third embodiment. For example, the third modification example is a fixed type, in which the ID codes of the plural wireless switches are stored in the function table in the memory of the LED power unit in advance. However, it may be provided with an operating unit such as a key switch in the casing of the LED power unit to have a function that allows a user to operate a wireless switch while or immediately after the operating unit is operated and then register newly or additionally the ID code transmitted from the wireless switch in the function table in the memory of the LED power unit.

In this case, the third modification example may be configured so that the correspondence of light control functions to the ID codes can be changed and registered according to the number of times of operating the key switch or the kind of the key switch to be selected in a case where plural key switches are provided.

Also, instead of using the plural wireless switches having different ID codes, the LED power unit can be controlled by a remote control that can transmit plural kinds of command codes.

In the foregoing description, the present invention has been applied to an LED lighting system as a background field. However, the present invention is not limited to it but can be applied to a lighting system with use of lighting fixtures other than LED lamps, an acoustic system or an audio assist system in which plural loudspeakers are installed, an aroma emitting system in which plural aroma emitting devices that can emit arbitrary aromas are installed, etc.

The entire disclosure of Japanese Patent Application No. 2010-089085 filed on Apr. 8, 2010 and Japanese Patent Application No. 2010-138315 filed on Jun. 17, 2010 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A power control device capable of controlling illuminance of a lighting fixture by outputting current that drives the lighting fixture and controlling the current, comprising:
a first circuit section including a receiver for receiving a wireless signal having a predetermined frequency, a control signal generating circuit for generating a control signal according to the number of times of reception of the wireless signal at the receiver, and a first alternating current-direct current conversion circuit for converting alternating-current voltage into direct-current voltage; and
a second circuit section for generating and outputting current according to the control signal from the first circuit section, the second circuit section including a second alternating current-direct current conversion circuit for converting alternating-current voltage into direct-current voltage,
wherein the first alternating current-direct current conversion circuit is in a state of being operated at all times, and the second alternating current-direct current conversion circuit is operated when outputting driving current for the lighting fixture according to the control signal from the control signal generating circuit and is not operated when not outputting driving current.

2. The power control device according to claim 1, wherein illuminance of the lighting fixture is changed by changing the magnitude of driving current for the lighting fixture to be output from the second circuit section according to the number of times of reception of the wireless signal.

3. The power control device according to claim 1,
wherein the lighting fixture is an LED lamp incorporating a red LED, a blue LED, and a green LED,
wherein the second circuit section is configured to be capable of outputting respective driving currents for the respective colors of the LED lamp, and
wherein the second circuit section is capable of changing an emission color of the lighting fixture by changing the number and combination of the driving currents to be output according to the number of times of reception of the wireless signal at the receiver.

4. The power control device according to claim 1, wherein the control signal generating circuit includes:
a counter for counting the number of times of reception of the wireless signal; and
a decoder for decoding a value of the counter to generate the control signal.

5. The power control device according to claim 1, wherein the control signal generating circuit includes:
a counter capable of automatic incremental update and decremental update;
a conversion circuit configured to convert a value of the counter to generate the control signal; and
a counter operation control section configured to change the operation state of the counter in response to reception of the wireless signal at the receiver.

6. The power control device according to claim 1, wherein the control signal generating circuit includes:
a storage unit that has stored therein an ID code,
an identify section for identifying an ID code contained in the wireless signal received at the receiver, and
a counter operation control section for changing the operation state of the counter in a change mode associated with the ID code contained in the wireless signal received at the receiver.

7. A lighting system comprising:
the power control device according to claim 1;
a lighting fixture driven to be lit by the power control device; and
a switch device incorporating a switch button and an energy self-supplying unit converting an operating force of the switch button into electric energy,
wherein the switch device includes a transmitter capable of transmitting a wireless signal having a predetermined frequency and is configured to transmit the wireless signal when the switch button is operated.

8. A lighting system comprising:
a plurality of switch devices each incorporating a switch button and an energy self-supplying unit converting an operating force of the switch button into electric energy;
a plurality of lighting fixtures; and
the power control devices according to claim 6 provided to correspond respectively to the plurality of lighting fixtures,
wherein each of the plurality of switch devices is configured to be capable of transmitting a wireless signal containing a unique ID code, and each of the power control devices changes driving current to be output to the corresponding lighting fixture when receiving the wireless signal containing a predetermined ID code.

9. The lighting system according to claim 8, wherein the power control device includes a transmitter for transmitting a wireless signal containing the ID code contained in the wireless signal received at the receiver.

10. The lighting system according to claim 7, wherein the switch device is configured as a device incorporating the energy self-supplying unit in a portable-size casing and provided with the switch button on the surface of the casing.
